(19) United States
(12) Patent Application Publication
(10) Pub. No.: US 2006/0167778 A1
(43) Pub. Date: Jul. 27, 2006

(54) Object-oriented financial modeling

(75) Inventors: Michael Hoffmann, Salem, MA (US); J. Craig Cleaveland, Windham, NH (US)

Correspondence Address: SULLIVAN & WORCESTER LLP, ONE POST OFFICE SQUARE, BOSTON, MA, 02109, US

(73) Assignee: Whitebirch Software, Inc., Salem, MA (US)

(21) Appl. No.: 11/230,256

(22) Filed: Sep. 19, 2005

Related U.S. Application Data
(60) Provisional application No. 60/611,898, filed on Sep. 21, 2004.

(51) Int. Cl. G06F 17/30; G06Q 40/00; G06F 7/00

(52) U.S. Cl. 705/35; 707/1

(57) ABSTRACT

Software technology is used to build and perform object-oriented financial modeling. A software framework creates highly reusable and layered business objects. Business objects organize financial information and save time through ease of use and a simple intuitive interface.

### CROSS-REFERENCE TO RELATED APPLICATIONS

This application claims priority to U.S. Provisional Patent Application No. 60/611,898, filed Sep. 21, 2004, the entire disclosure of which is incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISK

Not Applicable.

### REFERENCE TO A “MICROFICHE APPENDIX”

Not Applicable.

### BACKGROUND OF THE INVENTION

This invention relates generally to financial modeling, and, more particularly, to financial modeling software for use in generating financial reports.

### DESCRIPTION OF RELATED ART

Every business irrespective of its age and size must at one time or another perform financial planning as a critical activity for managing cash flow and communicating the financial health of the business. For new businesses, the preparation of financial projections is integral to the business planning process. For larger companies, financial planning forms part of annual budgeting and plays an important role in long-term planning, business appraisals, corporate development etc.

Common software tools that are used to manage such complex financial planning models include spreadsheet programs and proprietary accounting software with fixed (static) computational formulas and result outputs.

Spreadsheet applications do not generally provide standard formulas but rather depend on customizable templates that rely on software native algorithms. Spreadsheets also do not generally provide any standard reports. These, too, must generally be defined and tailored to specific business models and objectives. With spreadsheets, the vast majority of time is often spent on administrative tasks, leaving little time for strategic thinking.

On the other hand, proprietary accounting software tools are often too rigid in their approach to financial modeling and do not generally provide any means to dynamically tune the underlying formulas to match current business objectives or conditions.

### BRIEF SUMMARY OF THE INVENTION

In accordance with an embodiment of the invention, a method of modeling a financial entity includes representing elements of the financial entity as business objects. For each business object, parameters and formulas are specified. The formulas for each business object indicate the business object's contribution to at least one line item of a financial report. The method further includes generating the line item(s) responsive to the parameters and formulas specified in the business objects.

In accordance with another embodiment of the invention, a computer-implemented system for modeling a financial entity includes business objects that represent the financial entity. A user interface is provided for specifying parameters for each business object, and a plurality of formulas prescribe each business object's contribution to line items of financial reports. The system further includes software for creating the financial reports responsive to the parameters and formulas specified for the business objects.

In accordance with yet another embodiment of the invention, a computer-implemented system for modeling a financial entity includes object means for representing a plurality of elements of the financial entity and means for specifying parameters of each object means. The system further includes means for prescribing each object means' contribution to at least one financial report and means for creating line items in the one financial report(s) responsive to the prescribed contributions.

### DETAILED DESCRIPTION OF THE PREFERRED EMBODIMENT

Business Building Blocks (BBB's) is a set of software technologies used to build and perform object-oriented financial modeling. A software framework is used for creating highly reusable and layered business objects. Business objects organize financial information and save time through ease of use and a simple intuitive interface.

Business objects reduce the complexities and possible errors when designing complex financial models. A business object incorporates knowledge about a business entity such as revenues, expenses, assets, debts, and equity. Each business object can have any number of parameters that specify the details about the financial entity for which it represents. For example, a loan business object might include start date, interest rate, amount, type of loan, etc. From the parameters, the system can construct the line items required by various financial reports such as the income statements, balance sheets, and cash flow statements.

Using object-oriented financial modeling, users work with financial business objects rather than rows, columns and cells as is done in traditional spreadsheets. The benefit in this approach is obvious, as for example, spreadsheets do not know that a balance sheet is supposed to balance. Business objects also contain formulas and logic needed to create various financial reports. Business objects can be easily organized to match dynamic business (decision based) requirements. Using a model layering technology, parameters and projections can have different values enabling multiple scenarios without compromising the underlying model. The modeling platform allows new objects to be created and added seamlessly while allowing these extensions to leverage an existing underlying model.

Business objects may also be used offline or online in a collaborative model through the Internet or a corporate network such as an intranet.

This invention can be used for many purposes, including constructing and comparing financial scenarios, sensitivity analysis, and comparing model results against actual results. Using building business blocks to create business objects provides a powerful platform for maintaining multiple complex financial models in a consistent and reliable manner. Unlike traditional approaches that can, and often do, compromise the integrity of the computation model, business objects provide stable financial models while still allowing dynamic model composition.

Having described one embodiment, numerous alternative embodiments or variations can be made. Those skilled in the art will therefore understand that various changes in form and detail may be made to the embodiments disclosed herein without departing from the scope of the invention hereof.

What is claimed is:

1. A method of modeling a financial entity, comprising:
representing elements of the financial entity as a plurality of business objects;
specifying a plurality of parameters of each business object;
specifying a plurality of formulas for each business object indicative of the business object's contribution to at least one line item of a financial report; and
generating the at least one line item responsive to the parameters and formulas specified in the plurality of business objects.

2. A method as recited in claim 1, further comprising generating at least one financial report responsive to the parameters and formulas specified by the plurality of business objects.

3. A method as recited in claim 2, further comprising, for each business object,
specifying logic indicative of the business object's contribution to the at least one line item,
wherein the step of generating at least one financial report generates the at least one financial report responsive to the logic specified in the plurality of business objects.

4. A method as recited in claim 2, wherein the step of generating the at least one financial report is performed by software.

5. A method as recited in claim 1, further comprising creating and adding at least one new business object to an existing model.

6. A method as recited in claim 1, wherein at least one of the business objects is a loan business object.

7. A method as recited in claim 6, wherein the plurality of details for the loan business object includes at least one of start date, interest rate, amount, and type of loan.

8. A method as recited in claim 1, wherein the plurality of business objects comprises business objects relating to any of revenues, expenses, assets, debts, and equity.

9. A method as recited in claim 1, wherein business objects are reusable for modeling different financial entities.

10. A method as recited in claim 1, wherein each business object can have an arbitrary number of parameters.

11. A method as recited in claim 1, further comprising using the plurality of business objects offline.

12. A method as recited in claim 1, further comprising using the plurality of business objects in a collaborative model online using a corporate network.

13. A method as recited in claim 1, further comprising using the plurality of business objects in a collaborative model online using the Internet.

14. A method as recited in claim 1, further comprising providing different values for the parameters for modeling the financial entity under different scenarios.

15. A method as recited in claim 14, wherein the different values are maintained by a layering technology.

16. A method as recited in claim 14, further comprising performing a sensitivity analysis.

17. A method as recited in claim 14, further comprising comparing model results against actual results.

18. A method as recited in claim 1, further comprising generating a plurality of financial reports for the entity responsive to the parameters and formulas specified by the plurality of business objects.

19. A computer-implemented system for modeling a financial entity, comprising:
a plurality of business objects representing the financial entity;
a user interface for specifying a plurality of parameters for each business object;
a plurality of formulas prescribing each business object's contribution to line items of a plurality of financial reports; and
software for creating the plurality of financial reports responsive to the parameters and formulas specified for the plurality of business objects.

20. A system as recited in claim 19, wherein the at least one financial report comprises at least one of an income statement, a balance sheet, and a cash flow statement.

21. A computer-implemented system for modeling a financial entity, comprising:
object means for representing a plurality of elements of the financial entity;
means for specifying a plurality of parameters of each object means;
means for prescribing each object means' contribution to at least one financial report; and
means for creating line items in the at least one financial report responsive to the prescribed contributions.

22. A system as recited in claim 21, wherein the at least one financial report comprises at least one of an income statement, a balance sheet, and a cash flow statement.
